(19) United States
(12) Patent Application Publication
(10) Pub. No.: US 2009/0284025 A1
(43) Pub. Date: Nov. 19, 2009

(54) LOCK

(76) Inventor: Andrew Philip SALCOMBE, Gloucester (GB)

Correspondence Address: General Electric Company;GE Global Patent Operation, PO Box 861, 2 Corporate Drive, Suite 648, Shelton, CT, 06484, US

(21) Appl. No.: 12/434,926

(22) Filed: May 4, 2009

(30) Foreign Application Priority Data
May 16, 2008 (GB) 0808972.4

(51) Int. Cl. E05C 3/06

(52) U.S. Cl. 292/201

(57) ABSTRACT

A lock configured to lock retractable devices such as retractable landing gear for aircraft in a retracted position. The lock comprises a pivotally mounted hook member with a hook portion arranged to maintain a capture pin attached for example to retractable landing gear in a predetermined position when locked. A pivotally mounted first stage latch assembly is provided having a portion arranged to engage with a corresponding portion on the pivotally mounted hook member. A pivotally mounted second stage latch assembly is also provided having a portion arranged to engage a corresponding portion of the first stage latch assembly to maintain the first stage latch assembly and hook member in the predetermined locked position.

### CROSS-REFERENCE TO RELATED APPLICATIONS

This application claims priority under 35 U.S.C. § 119(a)-(d) or (f) to prior-filed, co-pending British patent application serial number 0808972.4, filed on May 16, 2008, which is hereby incorporated by reference in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

The field of the invention relates to a lock, for example to lock retractable components such as retractable landing gear for aircraft or doors in a retracted position. When not in use, retractable landing gear is required to be securely held in a retracted “up-lock” condition in a suitably shaped stowage zone in an aircraft.

2. Description of Related Art

Locks for holding retractable landing gear in an up-lock condition generally include a hook or like member pivotally mounted upon an aircraft and co-operable with a pin or the like attached to a portion of the retractable landing gear. Upon retraction of the landing gear, the hook automatically locks on to the pin. For subsequent release of the pin to permit re-extension of the landing gear, the hook is rotated about its pivotal mounting by suitable fluid-pressure operable or high powered electrically operable actuators via a latch.

GB-A-2 161 202 describes such a lock mounted on an aircraft co-operable with a pin mounted on the releasable landing gear. The lock includes a pivotable hook to engage the pin. In order to unlock the pin, a hydraulic jack is extended by the application of fluid under pressure thereto, such that its piston rod causes a latch to move in a clockwise direction, releasing a roller from engagement with a recess. This permits the pivotable hook to rotate under the weight of the releasable landing gear on the pin such that the pin is released from the hook and the landing gear is released.

A relatively high power hydraulic jack is required to release the lock because of the high pressure of the pin on the hook, caused by the weight of the releasable landing gear. However, it is generally desirable to avoid the use of hydraulic systems, since their use involves generating fluid pressure by the aircraft engines thus reducing the engines efficiency. Furthermore, hydraulic systems require regular maintenance and may suffer from leaks.

Alternatively, prior to re-extension of the landing gear, it can be raised to release the pressure applied by the pin on the hook. However, this pre-lifting of the pin subjects it to an additional fatigue cycle requiring a stronger and heavier pin and landing gear. Furthermore, the pre-lifting introduces a delay into the release of the landing gear.

### BRIEF SUMMARY OF THE INVENTION

According to a first aspect of the present invention, there is provided a lock for locking retractable aircraft landing gear in a retracted position. The lock comprises a pivotally mounted hook member with a hook portion arranged to maintain a capture pin in a predetermined position when locked. A pivotally mounted first stage latch assembly is provided having a portion arranged to engage with a corresponding portion of the pivotally mounted hook member. A pivotally mounted second stage latch member assembly is also provided having a portion arranged to engage a corresponding portion of the first stage latch assembly to maintain the first stage latch assembly and hook member in the predetermined locked position. An unlocking device is arranged to rotate the second stage latch member assembly about its pivot such that it is no longer engaged with the first stage latch member and so that the first stage latch assembly and hook member rotate about their pivots to an unlocked position to release a capture pin.

By using two latch members an unlocking device requiring considerably less power may be used without the need to raise the landing gear to off-load the hook member. Consequently, a low power device such as a solenoid may be used as the unlocking device reducing the size of the actuator, power consumed during use and costs of the device. Conventional unlocking devices such as hydraulic actuators, electro-mechanical actuators etc, can still be used but they can be designed to be much smaller and to use much less power than in conventional locks. Once the second stage latch member assembly has been rotated about its pivot by the unlocking device, the hook member may be rotated due to the downward force provided by the capture pin or by the action of a resilient member on the hook member or both.

### BRIEF DESCRIPTION OF THE DRAWINGS

Embodiments of the present invention will now be described, by way of example only, with reference to the accompanying drawings in which:

FIG. 1 shows an aircraft retractable landing gear and associated up-lock for holding the landing gear in its retracted condition;

FIG. 2 shows an example of a lock embodying the present invention;

FIG. 3 shows a more detailed example of the lock in a locked position;

FIG. 4 shows the lock being unlocked;

FIG. 5 shows the lock in an unlocked condition; and

FIG. 6 shows the direction of forces between co-acting components of the lock.

### DETAILED DESCRIPTION OF THE INVENTION

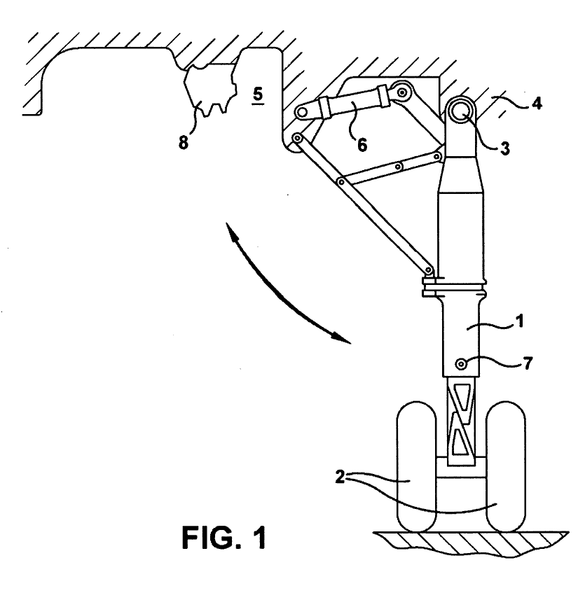

The retractable landing gear shown in FIG. 1 comprises a leg 1 which carries wheels 2 and which is pivotally mounted 3 to a fixed aircraft structure 4. The landing gear is retracted about pivotable mounting 3 into stowage zone 5 by a suitable fluid pressure operable retraction jack 6. When retracted, the landing gear reaches its stowed condition in zone 5 with pin 7 attached to leg 1 engaging up-lock 8 disposed in zone 5 attached to the fixed aircraft structure.

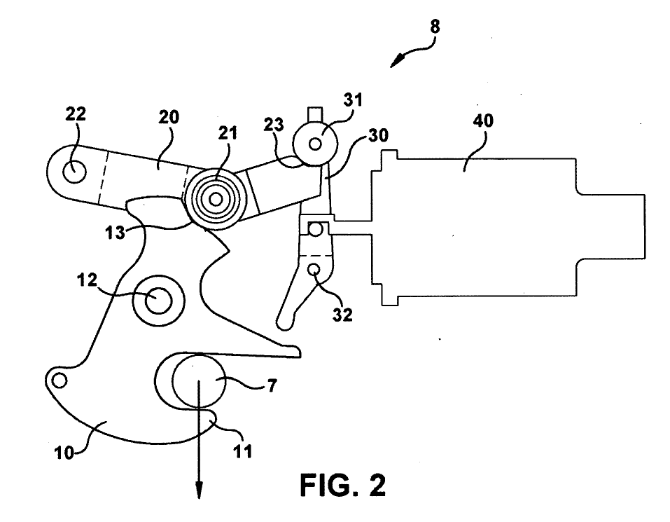

FIG. 2 shows the main parts of the lock 8. The lock 8 includes hook member 10 with a hook 11 in a locked position contacting pin 7. When in the locked position as shown in FIG. 2, the hook 11 reacts the applied download from pin 7. The hook member 10 is arranged to rotate about a pivot 12. A first stage latch assembly 20 has a portion 21 which is arranged to engage a portion 13 of the pivotally mounted hook member 10. The first stage latch assembly 20 is arranged to rotate around a pivot 22. A second stage latch member assembly 30 has a portion 31 arranged to engage a portion 23 of the first stage latch assembly 20. The engagement between the second stage latch assembly 30 and first stage latch assembly 20 maintains the first stage latch assembly 20 and hook member 10 in the predetermined locked position. The second stage latch assembly 30 is arranged to rotate around pivot 32. An unlocking device 40 is arranged to rotate the second stage latch assembly 30 clockwise about its pivot 32 as shown in FIG. 2 such that the first stage latch member assembly 20 and hook member 10 rotate about their pivots 22, 12 to an unlocked position to release the pin 7. In this example as the download applied by the pin 7 is offset from the hook member pivot 12, the hook member 10 tends to rotate clockwise about its pivot 12 as shown in FIG. 2 releasing the pin 7. In this example the clockwise rotation of the hook member 10 forces the first stage latch assembly 20 to rotate anticlockwise about pivot 22 as shown in FIG. 2 when it is no longer locked in place by the second stage latch assembly 30.

The provision of two latch assemblies 20, 30 enables the lock 8 to be unlocked by the unlocking device 40 with a significantly reduced output force. Furthermore, the length of the stroke required by the unlocking device 40 is significantly reduced compared to conventional locks.

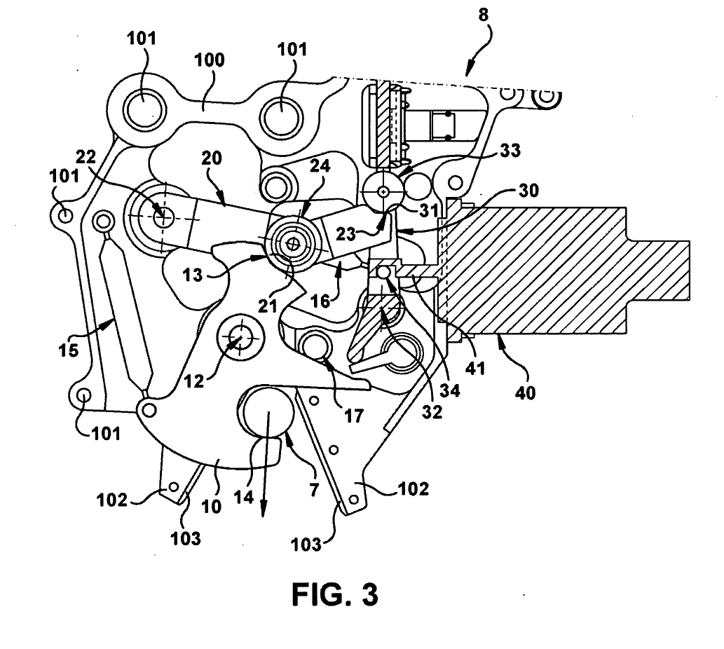

FIGS. 3 to 5 show a more detailed example of the lock 8. In the examples shown in FIGS. 3 to 5 the lock is provided on a frame structure 100 which has a number of bolt holes 101 enabling the frame structure 100 to be connected to a fixed aircraft structure 4. In use a covering plate (not shown) would be provided over the lock 8 and connected to the frame structure 100 in order to provide the pivot points 12, 22 and 32. In the examples shown in FIGS. 3 to 5 two optional guide members 102 are provided to guide the pin 7 into the lock 8 during retraction of the landing gear. In this example, the guide members 102 have protective layers 103 to prevent damage to the pin 7 or the guide members 102 upon insertion of the pin 7 into the lock 8.

When in the locked position shown in FIG. 3, the hook member 10 reacts the applied download from the pin 7 which pushes against an inner surface 14 of the hook member 10. As the download from the pin 7 is applied at a horizontal offset to the hook member pivot 12, the hook member 10 tends to rotate about the hook member pivot 12 in a clockwise direction as shown in FIGS. 2 to 5.

The download applied by the pin 7 onto the hook member 10 urges the contact portion 13 of the hook member into contact with a portion 21 of the first stage latch assembly 20. In this example, the portion of the first stage latch assembly arranged to contact the hook member 10 is a roller 24 to provide enhanced contact. At the point of contact 13 between the hook member 10 and the first stage latch roller 24, the geometry of the hook member 10 is configured to ensure that the first stage latch assembly 20 tends to rotate away from the hook member 10 about the first stage latch assembly pivot 22 when released.

The first stage latch assembly 20 is urged to rotate anticlockwise about its pivot 22 until it contacts with the portion 31 of the second stage latch assembly 30. In this example the portion 31 of the second stage latch member 30 which engages with the first stage latch member 20 is a roller 33. At the point of contact 23 between the first stage latch assembly 20 and the second stage latch roller 33, the geometry of the first stage latch assembly 20 is specifically configured to ensure that the second stage latch assembly 30 tends to rotate about its pivot 32 anticlockwise towards the first stage latch assembly 20 to maintain the arrangement in a locked state.

With the lock in the configuration described above and as shown in FIG. 3, the applied load from the pin 7 tends to hold the second stage latch assembly 30 engaged with the first stage latch assembly 20 thus locking the hook member 10 in the locked position.

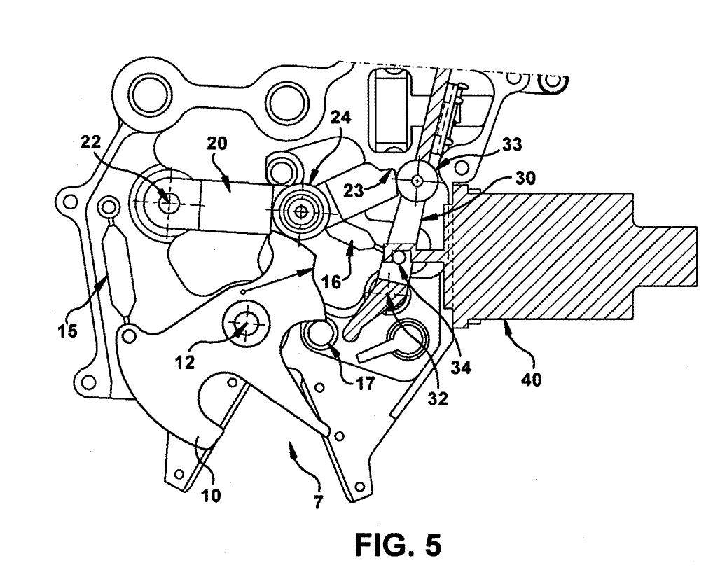

In the examples shown in FIGS. 3 to 5, there are one or more optional hook tension or resilient members, such as springs 15. These one or more tension members provide a force that tends to rotate the hook member 10 in a clockwise direction, thus loading the second stage latch assembly 30 and maintaining the lock 8 in the locked condition even when there is not a download applied to the hook member 10. The tension members 15 also provide a force that tends to rotate the hook member 10 into an open position ready to receive a pin 7 of a retracting landing gear when the second stage latch assembly is not in the locked position as described later with reference to FIG. 5, thus allowing the lock 8 to be maintained in an unlocked position without an external force being applied to the hook member 10.

In the Examples shown in FIGS. 3 to 5 there are one or more optional latch member assembly tension or resilient members, such as springs 16. These tension members provide a force to hold the second stage latch assembly 30 in contact with the first stage latch assembly 20 and maintain the second stage latch assembly 30 in the locked position.

The unlocking of the lock 8 will now be described.

With the pin 7 applying a download to the hook member 10 as shown in FIG. 3, the unlocking device 40 is instructed by a control device to retract. The unlocking device 40 retracts an actuator 41 until it contacts a pin 34 provided on the second stage latch member 30. The unlocking device typically momentarily stalls at this point until it generates enough force to overcome the forces being generated by the applied load and the geometry of the hook member 10, first stage latch assembly 20 and second stage latch assembly 30. In some situations the unlocking device 40 is arranged such that it cannot generate enough load to unlock the hook member 10, first stage latch assembly 20 and second stage latch assembly 30 whilst a download is applied to the hook member 10 via the pin 7. In these situations the retractable landing gear is configured to ensure that the pin 7 generates an upload prior to the unlocking device being instructed to move.

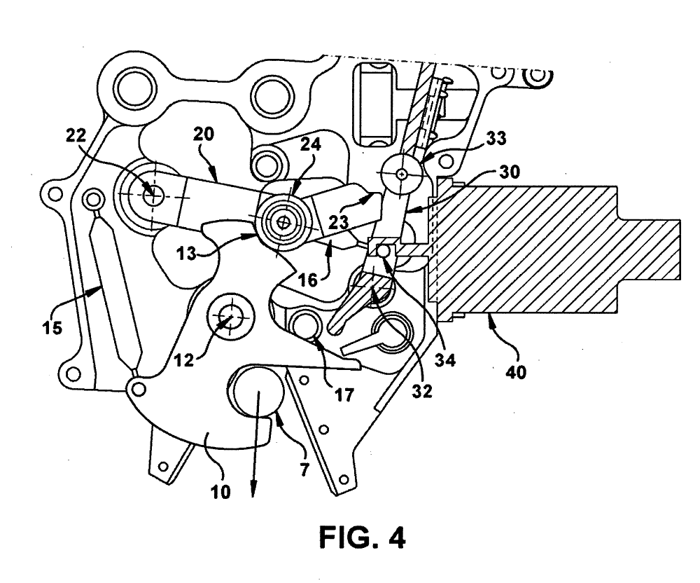

Once the unlocking device 40 generates enough force, it will start to rotate the second stage latch assembly 30 clockwise about its pivot 32 until the second stage latch roller 33 disengages from the first stage latch assembly 20 as shown in FIG. 4.

Once the second stage latch member 30 is disengaged, the force from the download provided by pin 7 or the force from the hook member tension members 15 or both rotate the hook member 10 clockwise about its pivot 12 and rotate the first stage latch assembly 20 anti-clockwise about its pivot as shown in FIG. 5.

The lock 8 is now in its unlocked condition and the hook member 10 will rotate until it comes into contact with a hook stop pin 17.

It has been found that in embodiments of the present invention an unlocking device 40 with considerably reduced output force is required and with significantly shorter movement strokes than prior systems can be provided. Consequently, a powerful hydraulic device which requires high pressure fluid generated by an aircraft's engine thus reducing the engines efficiency is not required. Instead a lower power actuator such as a solenoid or electro-mechanical actuator for example may be used as the unlocking device 40.

It has been found that selection of appropriate geometry of the hook member 10 where it contacts the first stage latch assembly 20 affects the amount of load that is transmitted to the second stage latch assembly 30 and consequently how much load the unlocking device needs to generate to unlock the lock 8.

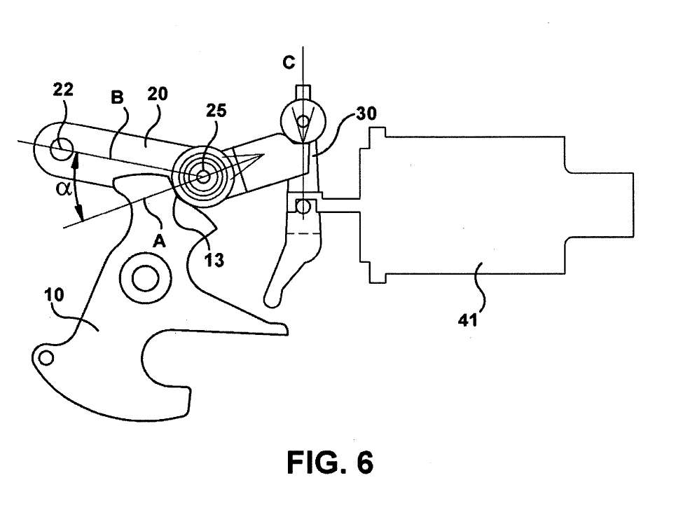

As shown in FIG. 6, it has been found that the vector for the load transferred to the second stage latch member 30 is normal to the hook member contact surface 13 at the contact point through the first stage latch roller centre point 25 as shown by arrow A in FIG. 6. By reducing the angle a shown in FIG. 6 between arrow A and the line B between pivot 22 and the first stage latch roller centre point 25, the force tending to rotate the first stage latch 10 (Force C shown in FIG. 6) is reduced. Consequently the power required by unlocking device 40 is also reduced.

The angle a may be arranged to be at any suitable angle between 5° and 80° for example depending upon the particular application.

A further advantage of this lock 8 with a two stage latch assembly is that the geometry at the contact point between the hook member 10 and the first stage latch assembly 20 can be configured to transmit as little or as much of the load as is required for a particular configuration. Configuring the geometry of the lock such that only a small proportion of the load is transferred to the second latch assembly 30 will result in a smaller unlocking device being required that uses lower levels of power to operate.

A further advantage of the two stage latch assembly lock is that because the load that is transferred to the second stage latch assembly 30 is lower, the second stage latch assembly components can be made smaller. Small second stage latch assembly components result in a reduction in the travels necessary to move from the locked to the unlocked position (and vice versa) resulting in reduced strokes.

When compared to a more conventional single stage lock of an equivalent size, the required unlocking device output force has been found to be reduced from over 300 lbs to approximately 180 lbs and the stroke requirements are reduced from 0.310 inches to 0.060 to 0.080 inches.

Many variations may be made to the examples described above without departing from the scope of the invention. For example, the hook member 10, first stage latch assembly and second stage latch assembly may be arranged to pivot in either direction as appropriate in particular arrangements when being locked or unlocked. Furthermore the lock may be used in any appropriate application.

1. A lock for locking retractable aircraft components in a retracted position, the lock comprising:
a pivotally mounted hook member with a hook portion arranged to maintain a capture pin in a predetermined position when locked;
a pivotally mounted first stage latch assembly having a portion arranged to engage with a portion of the pivotally mounted hook member;
a pivotally mounted second stage latch assembly having a portion arranged to engage a portion of the first stage latch assembly to maintain the first stage latch assembly and hook member in a predetermined locked position; and
an unlocking device arranged to rotate the second stage latch assembly about its pivot such that the first stage latch assembly and hook member rotate about their pivots to an unlocked position to release a capture pin.

2. The lock according to claim 1, wherein the hook member pivot is offset horizontally, when in use, from a download provided by the pin engaged with the hook member when in the locked position such that when unlocked, the download provided by the pin rotates the hook member about its pivot to the unlocked position to release the capture pin.

3. A lock according to claim 1, wherein one or more hook tension members provide a force that tends to rotate the hook member into an unlocked position.

4. The lock according to claim 1, wherein the first stage latch assembly has a roller which is arranged to engage with a corresponding portion of the pivotally mounted hook member.

5. A lock according to claim 4, wherein load is transferred at the contact point between the hook member and the roller of the first stage latch assembly and the angle between the normal to the contact surface between the hook member and the first stage latch roller centrepoint (A) and a line between the first stage latch assembly pivot and the roller centrepoint is between 5° and 80°.

6. A lock according to claim 1, wherein the second stage latch assembly has a roller arranged to engage a corresponding portion of the first stage latch assembly.

7. A lock according to claim 1, wherein one or more tension members are provided to urge the second stage latch assembly into contact with the first stage latch assembly to maintain them in a locked position.

8. A lock according to claim 1, wherein the unlocking device is a solenoid.

9. A lock according to claim 1, wherein the unlocking device is a electro-mechanical actuator or a hydraulic actuator.

10. An aircraft including a lock according to claim 1.

11. (canceled)
